(19) United States
(12) Patent Application Publication
(10) Pub. No.: US 2007/0112715 A1
(43) Pub. Date: May 17, 2007

(54) SYSTEM FAILURE DETECTION EMPLOYING SUPERVISED AND UNSUPERVISED MONITORING

(75) Inventors: Haifeng Chen, PLAINSBORO, NJ (US); Guofei Jiang, PRINCETON, NJ (US); Cristian Ungureanu, PRINCETON, NJ (US); Kenji Yoshihira, CRANFORD, NJ (US)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, Princeton, NJ (US)

(21) Appl. No.: 11/556,935

(22) Filed: Nov. 6, 2006

Related U.S. Application Data
(60) Provisional application No. 60/734,235, filed on Nov. 7, 2005.

(51) Int. Cl. G06N 5/02

(52) U.S. Cl. 706/46; 703/13

(57) ABSTRACT

A system failure detection method that employs both supervised and unsupervised monitoring that models the contextual dependencies between the system inputs u and database usages x. By means of statistical learning, the space x is transformed into two subsets of variables, \tilde{x}⁽¹⁾ and \tilde{x}⁽²⁾ . The subset \tilde{x}⁽¹⁾ encapsulates the dependencies of x with respect to the system load, and each variable in that subset has a highly correlated partner derived from the input u, which serves as a ‘teacher’ to monitor the activities of that variable. The subset \tilde{x}⁽²⁾ contains variables that are less correlated or uncorrelated with respect to the input and are monitored in an unsupervised manner. By combining the supervised and unsupervised monitoring, a high detection rate and minimal false positives are experienced, especially those resulting from workload changes.

### CROSS REFERENCE TO RELATED APPLICATIONS

This application claims the benefit under 35 U.S.C. § 119(e) of U.S. Provisional Application No. 60/734,235, filed Nov. 7, 2005, the entire contents and file wrapper of which are hereby incorporated by reference for all purposes into this application.

### FIELD OF THE INVENTION

This invention relates generally to the field of system failure detection. More particularly, it pertains to a method for detecting system failures that employs both supervised and unsupervised monitoring.

### BACKGROUND INFORMATION

Distributed computing systems are becoming increasingly complex and difficult to manage due to the interactions between workload, software structure, hardware, and traffic conditions—among others. Such complexities increase the potential for the systems and online services based upon these systems to suffer from various failures—many of which are user visible. For example, a bug in a certain software component may cause items not being added to a shopping cart or an error message being displayed. Other types of failures may result from a wide variety of human operator errors in addition to hardware and software faults.

There have been several research activities directed to detecting failures in electrical and mechanical systems and a number of methods have been proposed in those areas. However, whereas the disciplines of electrical and mechanical engineering have long been well understood, distributed computing and systems constructed therefrom are in their infancy. In addition, specific features of online distributed systems introduce new challenges for the failure detection task. For instance, there are no explicit physical models like in the mechanic systems to help the detection. Furthermore, a large percentage of actual failures in computing systems are partial failures, which only break down part of service functions and do not affect the operational statistics such as response time. Such partial failures cannot be easily detected by traditional tools, such as pings and heartbeats. It is imperative then to have more advanced techniques to cope with those failures.

### SUMMARY OF THE INVENTION

In an exemplary embodiment, the present invention is directed to a system failure detection method that may employ both supervised and unsupervised monitoring of the system. According to an aspect of the present invention, information pertaining to system input is collected and dependencies between that system input and internal states are formulated and used to determine failures.

In sharp contrast to prior-art methods which employ only unsupervised monitoring, the method according to the present invention is less susceptible to false positives precipitated by abrupt system workload variations.

Advantageously, the method according to the present invention defines implicit contextual relationships between the system input and its internal states thereby immunizing itself from these workload-variation-induced false positives. Operationally, the present invention utilizes the power of statistical learning and deep mines correlations between multiple system logs, such as HTTP access logs and database logs. In so doing, system failures are detected at their early stages when the phenomenon is/are very weak, thereby providing significant savings in time and cost to the management of large scale distributed systems.

Fortunately and as advantageously exploited by the present invention—business rules and logic are usually fixed for mission critical enterprise systems and there exist some contextual relationships between the system inputs and its internal states. For instance, to accomplish a specific type of client request, some components and system resources are always activated. Once the dependency between the system input and internal state variables is correctly learned, such knowledge can be utilized to help with failure detection. That is, the input data can be used as a “teacher” to monitor the observations of the system state. Once a failure happens, the system states that are usually affected and their observations will be clearly different from those expected from the system input. By detecting these discrepancies, a system or method in accordance with the present invention can capture the system failure.

According to an aspect of the present invention, database usages are represented as system observation x. Each variable in x represents the number of accesses of a specific database table within a certain time interval. An input vector u represents the system load in which each variable denotes the number of a specific type of client request issued within the time interval.

An exemplary embodiment of the present invention employs statistical approaches to learn the probabilistic dependencies between system load and database usages. By means of learning, the system variables x are transformed and divided into two subsets, \tilde{x}⁽¹⁾ and \tilde{x}⁽²⁾. Each variable in the subset \tilde{x}⁽¹⁾ has a highly correlated partner derived from the input u. The present invention provides a way of supervised monitoring to check the status of variables in the \tilde{x}⁽¹⁾ subset.

The variables in the subset \tilde{x}⁽²⁾ represent the less correlated and non-relevant information in x with respect to the input u. The \tilde{x}⁽²⁾ subset variables are monitored in an unsupervised fashion since they can not find a “teacher” from u. By combining the supervised and unsupervised monitoring, the present invention advantageously captures the activities of both subspaces of x.

It is shown that supervised monitoring is superior to unsupervised monitoring, especially when the variable is diverse and has completely unpredictable distribution. One explanation is that the supervised monitoring provides a dynamic baseline for the variable regardless of how uncertain it is. From the view of information theory, the distribution of the monitored variable under the condition of knowing the value of its “teacher” has much lower entropy than that of the distribution of that variable itself.

Two approaches to decomposing the space x into the two subsets \tilde{x}⁽¹⁾ and \tilde{x}⁽²⁾ are provided. The first is based on a traditional statistical method referred to as canonical correlation analysis (CCA). By means of CCA, the dependence between u and x is encapsulated in a number of variable pairs {ũᵢ,\tilde{x}ᵢ} with the canonical correlation ρᵢ=corr(ũᵢ,\tilde{x}ᵢ). The variable subset \tilde{x}⁽¹⁾ is extracted based on the magnitude of ρᵢ. A shortcoming of CCA-based decomposition is that it only takes into account the correlations between two sets of variables, and does not consider how representative the subset \tilde{e}⁽¹⁾ is. Given that supervised monitoring is more accurate than unsupervised monitoring, it is desirable that the variable subset \tilde{x}⁽¹⁾ represent the behavior of the whole set x as much as possible. That is, it is better for \tilde{x}⁽¹⁾ to capture more variances of the distribution x.

In a further aspect of the present invention, a new analysis technique is provided, referred to herein as principal canonical correlation analysis (PCCA). PCCA combines CCA with another data analysis technique known as principal component analysis (PCA). By way of PCCA, it is possible to find a subspace of x that is not only highly correlated with the input space but is also a significant representative of the original space x.

In a further exemplary embodiment of the present invention, information relating to system load and/or state is obtained directly from system logs. The system load u can be obtained from HTTP access logs, and the database usages x are available from database logs. Advantageously, this avoids the high overhead requirements of known approaches which employ some specifically designed instrumentation tools to collect low-level measurements in order to learn the high-level behavior of a system. Moreover, by taking advantage of statistical learning, a detector in accordance with the present invention can still identify a wide variety of system faults that are hard to detect with traditional detection tools.

The present invention has been tested on a real e-commerce application hosted on a J2EE multi-tiered architecture. Some codes in the EJB components were modified to simulate a variety of real system faults. Both CCA and PCCA based detectors were applied and compared in detecting those failures. Experimental results demonstrate that both CCA and PCCA provide good performance in failure detection. The PCCA-based method, however, produces more reliable and clear evidences than the CCA-based approach when the impacts of injected failure are relatively weak.

The aforementioned and other features and aspects of the present invention are described in greater detail below.

### BRIEF DESCRIPTION OF THE DRAWINGS

FIG. 1A illustrates canonical correlation analysis (CCA) in which two sets of variables, u and x, are transformed into orthogonal pairs with descending canonical correlation;

FIG. 1B illustrates canonical correlation analysis (CCA) according to the present invention in which two sets of variables, u and x, are transformed into orthogonal pairs with descending canonical correlation showing both supervised variables and unsupervised variables;

FIGS. 2A-2F are demonstrate the process of this supervised monitoring;

FIG. 3 is a block diagram depicting an experimental test bed setup according to the present invention;

FIG. 4 is a table showing the correlation and extracted variance for each component calculated from CCA and PCCA for the experimental system according to the present invention;

FIG. 5 is a series of graphs for experimental Normal Case I showing (a) canonical correlation and s score obtained from CCA and (b) canonical correlation and s score obtained from PCCA wherein the dashed lines are the thresholds;

FIG. 6 is a series of graphs for experimental Normal Case II showing (a) canonical correlation and s score obtained from CCA and (b) canonical correlation and s score obtained from PCCA wherein the dashed lines are the thresholds;

FIG. 7 is a series of graphs for experimental Memory Leaking results showing (a) canonical correlation and s score obtained from CCA and (b) canonical correlation and s score obtained from PCCA wherein the dashed lines are the thresholds;

FIG. 8 is a schematic showing (a) File Missing error associated with multiple JSP requests and (b) HTTP requests completing without error for experimental File Missing;

FIG. 9 is a series of graphs for experimental File Missing results showing (a) canonical correlation and s score obtained from CCA and (b) canonical correlation and s score obtained from PCCA wherein the dashed lines are the thresholds;

FIG. 10 is a series of graphs for experimental Deadlock results showing (a) canonical correlation and s score obtained from CCA and (b) canonical correlation and s score obtained from PCCA wherein the dashed lines are the thresholds;

FIG. 11 is a series of graphs for experimental Busy Loop on Rare Requests results showing (a) canonical correlation and s score obtained from CCA and (b) canonical correlation and s score obtained from PCCA wherein the dashed lines are the thresholds;

FIG. 12 is a series of graphs for experimental Busy Loop on Frequent Requests results showing (a) canonical correlation and s score obtained from CCA and (b) canonical correlation and s score obtained from PCCA wherein the dashed lines are the thresholds;

FIG. 13 is a schematic diagram showing an example of expected exception fault;

FIG. 14 is a series of graphs for experimental Expected Exception Fault results showing (a) canonical correlation and s score obtained from CCA and (b) canonical correlation and s score obtained from PCCA wherein the dashed lines are the thresholds;

FIG. 15 is a schematic diagram showing an example of a null call fault; and

FIG. 14 is a series of graphs for experimental null call results showing (a) canonical correlation and s score obtained from CCA and (b) canonical correlation and s score obtained from PCCA wherein the dashed lines are the thresholds;

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

By way of some additional background and generally speaking, traditional failure detection techniques can be divided into two main categories: low-level and high-level detection techniques. The low level techniques, such as pings, heartbeats, and HTTP error code monitors are relatively easy to deploy because they are application generic, but they cannot detect application level failures, such as blank pages, wrong links, loops and so on. (See, e.g., M. K. Aguilera, W. Chen, and S. Toueg, “Using The HeartBeat Failure Detector For Quiescent Reliable Communication and Consensus In Partitionable Networks”, Theoretical Computer Science, Special Issue on Distributed Algorithms, 220:3-30, 1999; and E. Marcus and H. Stern “Blueprints for High Availability” John Wiley and Sons, Inc., New York, N.Y., 2000)

Fortunately, application-level service failures can be detected by some high level techniques, such as end-to-end tests of service functionality. Such high-level techniques, however, must be custom-built for each application and updated as the application evolves. An ideal detector then would be as easily deployable and maintainable as characteristic of the low-level techniques while providing more sophisticated detection capabilities exhibited by high level techniques.

Those skilled in the art will appreciate that statistical learning theory (SLT) has been successfully applied to the fields of computer vision, language understanding, and information retrieval, among others. One advantage of statistical learning is its capability of finding patterns or extracting knowledge from huge amount of data that are impossible for a human to analyze.

As a result, SLT has received growing attention in fault detection of distributed systems (See, e.g., G. Jiang, H. Chen, C. Ungureanu and K. Yoshihara, “Multi-Resolution Abnormal Trace Detection Using Varied-Length n-Grams and Automata”, Proceedings of the Second International Conference on Autonomic Computing (ICAC), Seattle, Wash., June 2005; and M. Chen, E. Kieiman, E. Frankin, A. Fox and E. Brewer, “Pinpoint: Problem Determination In Large, Dynamic Systems”, 2002 International Performance and Dependability Symposium, Washington, D.C., June 2002). For instance, probabilistic context free grammar (PCFG) and statistical χ₂ test have been proposed to detect abnormal client request traces in a system. Others (See, e.g., P. Bodik, G. Friedman, L. Biewald, et al, “Combining Visualization And Statistical Analysis To Improve Operator Confidence and Efficiency for Failure Detection and Localization”, in Proceedings of the Second International Conference on Autonomic Computing (ICAC 2005), Seattle, Wash., June 2005) used a Naïve Bayesian classifier to analyze the HTTP access logs and hence detect system failures. A major drawback of those approaches, however, is that they are not able to discriminate whether a system behavior change is occurring because of a true failure or just unusual workload variation, and hence are susceptible to many false positives.

Recent advances in SLT have enabled its application to the field of system availability. Unlike other methods, SLT based approaches find patterns or models of systems' normal and/or abnormal behavior from a large amount of sample data.

One such approach—a rule-based classification approach to recognize system failure behaviors—is described in Sahoo et al. (See, e.g., R. K. Sahoo, A. J. Oliner, I. Rish, M. Giupta, J. E. Moreira, S. Ma, R. Vilalta and A. Sivasubramanium, “Critical Event Prediction For Proactive Management In Large-Scale Computer Clusters”, In Proceedings of the ninth ACM SIGKDD International Conference on Knowledge Discovery and Data Mining, pp. 426-435, Washington, D.C. 2003). A simplified Bayesian network structure, called a tree-augmented naive (TAN) network, was used to model dependencies between system variables and thereby provide the automatic detection of service level agreement (SLA) violations was described in Cohen et al. (See, e.g., I. Cohen, S. Jeffrey, M. Goldszmidt, T. Kelly, and J. Symons, “Correlating Instrumentation Data to System States”: A Building Block for Automated Diagnosis and Control”, In 6^{th} Symposium on Operating Systems Design and Implementation (OSD104), San Francisco, Calif., December 2004).

Chen et al., has proposed using probabilistic context free grammar (PCFG) to model the path shapes of client requests, and the statistical χ² test to monitor the component interactions. In the same context of request shape analysis, others have described multi-resolution abnormal trace detection algorithms using variable-length Ngrams and automata while still others [See, e.g., H. Chen, G. Jiang, C. Ungureanu and K. Yoshihara, “Failure Detection and Localization in Component Based Systems by Online Tracking”, In Proceedings of the Eleventh ACM SIGKDD International Conference on Knowledge Discovery and Data Mining, Chicago, Ill., August 2005) considered dynamic tracking of high dimensional observations to detect system failures.

In order to learn the system high level behavior, many of the above methods employ some specifically designed instrumentation tools to collect low-level measurements. For instance, Chen et al. modified the middleware to collect the request traces in the J2EE platform. Similarly the commercially available software HP OpenView was used to gather required information from the distributed system for analysis. These instrumentations impose extra overhead on the system thereby negatively impacting system performance. For example, a typical system may experience a tremendous amount of client requests daily. Collecting and recording every request trace would consume an extraordinarily large amount of system resources.

Finally, it is understood that modeling the relationship between the system input and internal status has been studied in modern system and control theory. One such modeling methodology—the state-space approach—treats the whole system as a “multiple inputs and multiple outputs” (MIMO) model based on the physical properties of system or data samples. Several specific features of distributed systems, however, make it harder to apply those approaches directly to failure detection. For instance, the distributed computing system has no physically plausible model. Moreover, not all the variables of system input have relations with those of system state. The correlated subset of variables from each set thus needs to be extracted. Another challenge is that such relationships are not deterministic. For instance, some types of client request may or may not visit the database tables depending on the parameters in the request. The mechanism of connection pooling (See, e.g., Sun Microsystems, “J2EE Connector Architecture Specification”, Version 1.0—public draft http://java.sun.com/aboutJava/communityprocess/jsr/jsr_{—}016_connect.html, 2000) in most enterprise systems further increases the uncertainty of dependencies.

Canonical Correlation Analysis-Based Failure Detection

In an exemplary embodiment of the present invention, canonical correlation analysis (CCA) is used to detect system failures.

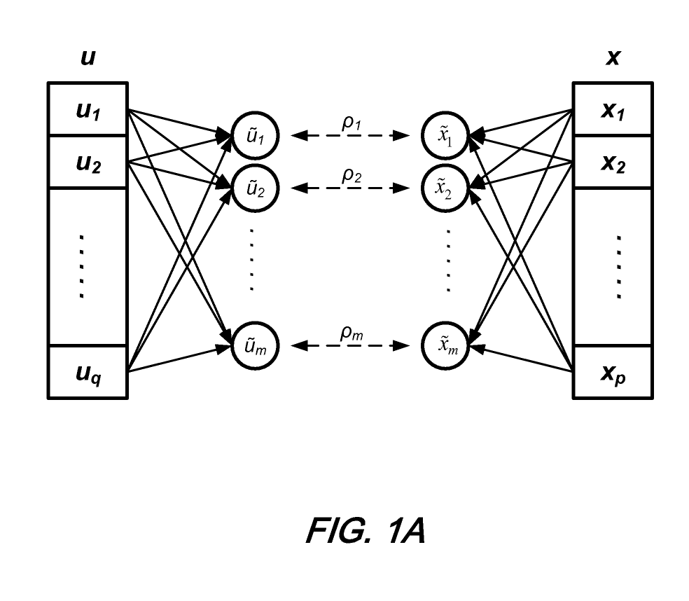

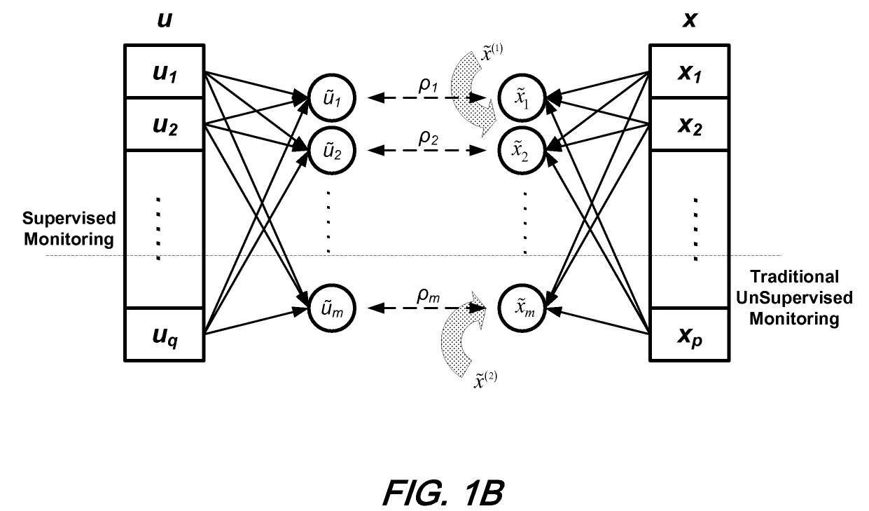

Canonical correlation analysis (CCA) studies the relationship between two sets of variables, u∈R^{q} and x∈R^{p}. It is known that even if there is a very strong linear relationship between two sets of multidimensional variables, depending on the coordinate system used, this relationship might not be visible as a correlation. CCA transforms both set of variables into pairs (ũᵢ,\tilde{x}ᵢ), as shown in FIG. 1, where i =1, 2, . . . , m and m=min(p, q), such that the ũᵢ are orthogonal, as are the \tilde{x}ᵢ, and the canonical correlations ρᵢ=corr(ũᵢ,\tilde{x}ᵢ) are descending, ρ₁≧ρ₂≧ . . . ρₘ. By doing so, the dependencies between x and u are encapsulated into a subset of variable pairs based on the values of canonical correlations.

The main part of CCA calculation is to find the transforming vectors wᵤ₍ᵢ₎ and wₓ₍ᵢ₎ that maximize the correlation between two variables, ũᵢ=wᵤ₍ᵢ₎^{T}u and \tilde{x}ᵢ=wₓ₍ᵢ₎^{T}x, under the condition that ũᵢ and \tilde{x}ᵢ are uncorrelated with their previous values ũᵢ₁, ũᵢ₂, . . . , ũ₁ and \tilde{x}ᵢ₁, \tilde{x}ᵢ₂, . . . , \tilde{x}₁, respectively.

$${ρ}_{i} = \frac{E ( {\tilde{u}}_{i} {\tilde{x}}_{i} )}{\sqrt{E ( {\tilde{u}}_{i}^{2} ) E ( {\tilde{x}}_{i}^{2} )}} = \frac{{w}_{u ( i )}^{⊤} {C}_{ux} {w}_{x ( i )}}{\sqrt{{w}_{u ( i )}^{⊤} {C}_{uu} {w}_{u ( i )} {w}_{x ( i )}^{⊤} {C}_{xx} {w}_{x ( i )}}} \qquad ( 1 )$$

In (1), Cᵤᵤ and Cₓₓ denote the within-set-covariance matrices of u and x respectively, and Cᵤₓ=Cᵤₓ^{T} is the between-sets-covariance matrix.

The case where only one pair of basis vectors is sought, namely the ones corresponding to the largest canonical correlation, is first considered. For simplicity, wᵤ or wₓ denote that pair of vectors. Since the solution of (1) is not affected by resealing wᵤ or wₓ, the problem formulated in equation (1) is equivalent to maximizing the numerator subject to:
wᵤ^{T}Cᵤᵤwᵤ=1 (2)
wₓ^{T}Cₓₓwₓ=1 (3)

The corresponding Lagrangian is

$$L ( λ , {w}_{u} , {w}_{x} ) = {w}_{u}^{⊤} {C}_{ux} {w}_{x} - \frac{{λ}_{u}}{2} ( {w}_{u}^{⊤} {C}_{uu} {w}_{u} - 1 ) - \frac{{λ}_{x}}{2 } ( {w}_{x}^{⊤} {C}_{xx} {w}_{x} - 1 ) \qquad ( 4$$

Taking derivatives of the Lagrangian with respect to wᵤ and wₓ one obtains:

$$\begin{matrix}\frac{ⅆ L}{ⅆ {w}_{u}} = {C}_{ux} {w}_{x} - {λ}_{u} {C}_{uu} {w}_{u} = 0 & ( 5 ) \\ \frac{ⅆ L}{ⅆ {w}_{x}} = {C}_{xu} {w}_{u} - {λ}_{x} {C}_{xx} {w}_{x} = 0 & ( 6 )\end{matrix}$$

Multiplying (6) by wₓ^{T}, (5) by wᵤ^{T} and subtracting the former from the later yields:

$$\begin{matrix}0 = {w}_{u}^{⊤} {C}_{ux} {w}_{x } - {λ}_{u} {w}_{u}^{⊤} {C}_{uu} {w}_{u} - {w}_{x}^{⊤} {C}_{xu} {w}_{u} + {λ}_{x} {w}_{x}^{⊤} {C}_{xx} {w}_{x} \\ = {λ}_{x} {w}_{x}^{⊤} {C}_{xx} {w}_{x} - {λ}_{u} {w}_{u}^{⊤} {C}_{uu} {w}_{u}\end{matrix} \qquad ( 7 )$$

Together with constraints (2) and (3), we conclude λᵤ=λₓ=ρ. When Cᵤᵤ is invertible, we get from (5):

$${w}_{u} = \frac{{C}_{uu}^{- 1} {C}_{ux} {w}_{x}}{ρ} \qquad ( 8 )$$

Substituting in equation (6) gives after rearranging
(CₓᵤCᵤᵤ¹Cᵤₓ−ρ²Cₓₓ)wₓ=0 (9)

In an analogous way we can get the equation for vector wᵤ as
(CᵤₓCₓₓ⁻¹Cₓᵤ−ρ²Cᵤᵤ)wᵤ=0 (10)

Hence wᵤ and wₓ are found by solving the generalized eigen problem of (9) and (10) respectively. They correspond to the eigen vectors of (9) and (10) with respect to the largest eigen value. Having extracted the first pair of transforming vectors, the next canonical pairs are found in a similar way. It has been shown that those solutions correspond to the eigen vectors of the same equations (9) and (10) but with different eigen values (See, e.g., H. Hotelling, “Analysis of A Complex of Statistical Variables Into Principal Components”, Journal of Educational Psychology, 24, 417-441, 1993)

Failure Detection by CCA

Returning our attention to FIG. 1, there it may be seen how CCA is used to detect failures according to the present invention. Given two sets of variables u∈R^{q} and x∈R^{p} where u is the system input and represents the number of different types of client request issued within certain time interval. The vector x corresponds to the usage frequencies of different database tables. The process of fault detection is to track the status variables x along time and identify the abnormal behavior of x with respect to its activities we already observed. However, merely concentrating on the variable set x itself for detection is not robust since some anomalies of x may not result from real faults but because of other factors such as the unusual workload changes. The purpose of using CCA is to make use of the system input u as a ‘teacher’ to provide a baseline for the activities of variables in x. It can remove the uncertainties of distribution x which are caused by the system input. In view of information theory, our strategy is to reduce the entropy of observations by means of considering the system input since we believe the mutual information between the status variables x and input u is high.

As described above, CCA transforms the two sets of variables u and x into pairs (ũᵢ,\tilde{x}ᵢ), where i=1, 2, . . . , m, with decreasing correlations ρ₁≧ρ₂≧ . . . ρₘ. Based on the value of ρ₁, the space x is decomposed into two subsets \tilde{x}⁽¹⁾ and \tilde{x}⁽²⁾. Each variable \tilde{x}ᵢ in subset \tilde{x}⁽¹⁾ has a partner ũᵢ from input u which is highly correlated (i.e., ρᵢ≧ρ^{*}, with ρ^{*}=0.9, in an exemplary embodiment). The variables in \tilde{x}⁽²⁾ represent the low correlation and uncorrelated part of x. Below we introduce two different strategies to monitor the variables in \tilde{x}⁽¹⁾ and \tilde{x}⁽²⁾, respectively.

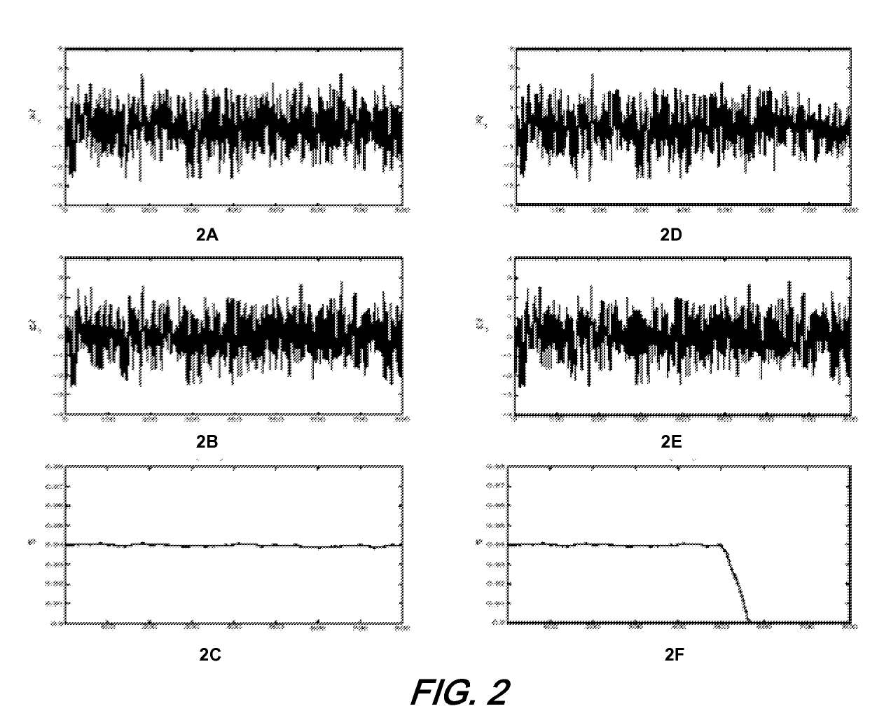

In an exemplary embodiment, supervised monitoring is employed for each variable \tilde{x}ᵢ in \tilde{x}⁽¹⁾. Its partner ũᵢ serves as a teacher to monitor the behavior of \tilde{x}ᵢ. FIGS. 2A-2F demonstrate the process of this supervised monitoring. The values of \tilde{x}₁ in system normal status and faulty status are plotted in FIGS. 2A and 2D, respectively.

As can be appreciated, it is hard to detect the system fault based on \tilde{x}₁ itself because the values of \tilde{x}₁ are very diverse. Knowing its highly correlated partner ũ₁, however, shown in FIGS. 2B and 2E, the correlation between ũ₁ and \tilde{x}₁ can be calculated and updated. FIGS. 2C and 2F illustrate the correlation curves in the normal and faulty cases, respectively. It can be seen that in the faulty case (FIG. 2F), the correlation between the signals \tilde{x}ᵢ and ũᵢ drops after the 500th observation because the system encountered some abnormal failures. Note that the horizontal axis in FIGS. 2A-2F represents the time dimension.

To implement this supervised detector, we need to 1) obtain the projection vector wᵤ₍ᵢ₎ and wₓ₍ᵢ₎ for each pair {ũᵢ,\tilde{x}ᵢ} and their correlation ρᵢ; 2) find ways of online updating the correlation ρᵢ for each new observation; and 3) determine the threshold for each ρᵢ that represents its deviation from normality. To accomplish this, we collect observations of x and u during system normal operations as the training data, and split them into two parts. The first dataset is used to extract the correlation model between x and u by using CCA. Hence we obtain the projection vectors and canonical correlation for each pair {ũᵢ,\tilde{x}ᵢ}. The second training set is used to determine the threshold for each ρᵢ.

Starting from the previous learned CCA model, we sequentially update the correlation ρᵢ for every observation. Given kth observation x^{k} and u^{k} from the data set, an exponentially weighted moving average (EWMA) filter is employed to update the within-set-covariance matrices, Cₓₓ and Cᵤᵤ and the between-sets-covariance matrix Cₓᵤ. For instance, the EWMA based update of between set covariance matrix is expressed as
Cₓᵤ^{k+1}=γCₓᵤ^{k}(1−γ)x^{k}(u^{k}) (11)
where the constant γ dictates the degree of filtering. When we choose

$$γ = \frac{1}{k + 1} ,$$

equation (11) changes into the traditional moving average (MA) estimation. In the EWMA filter, the parameter is fixed so that Cₓᵤ^{k+1} can “age out” old observations and put more importance to the recent data. This allows the algorithm to automatically adapt to the system changes. Previously, we choose γ=0.99. The two within-sets-covariance matrices are updated in the similar way. Note here it is assumed that x and u are zero-mean variables. If not, we can easily center them by subtracting them from the mean obtained from the first set of training data.

Once we obtain all the values of ρᵢ, its mean and standard deviation are calculated. The threshold is then determined as 3 times standard deviation below the mean. During the on-line monitoring process, we use the same way to update ρᵢ. Whenever the correlation is below a threshold, it is regarded that the system is in faulty behavior.

Since the variables in subset \tilde{x}⁽²⁾ can not find a highly correlated partner from the input u, they are monitored in an unsupervised manner. There are a variety of methods for unsupervised monitoring in the literature (See, e.g., Tsuyoshi Ide and Hisashi Kashima, “Eigenspace-Based Anomaly Detection in Computer Systems”, In Proceedings of the Tenth ACMSIGKDD International Conference on Knowledge Discovery and Data Mining, pp. 440-449, Seattle, Wash., August 2004) defined as follows:

$$s = {\sum }_{i = 1}^{{m}_{2}} {\tilde{x}}_{i}^{2} \qquad ( 12 )$$

where m₂ is the number of variables in \tilde{x}⁽²⁾ and \tilde{x}ᵢ is a zero-mean variable with unit standard deviation according to equation (3). If we assume that the values of \tilde{x}ᵢ are normally distributed, then s obeys the χ² distribution with degree of freedom m₂. The threshold of anomaly is then determined by choosing certain confidence level of χ² distribution. In the experiments, we choose a confidence level of ρ=0.999 to decide the threshold. The geometric interpretation of equation (12) is that the statistic s actually represents the distance between the projection of x into the subspace spanned by \tilde{x}⁽²⁾ and the origin of that subspace.

### EXPERIMENTAL RESULTS

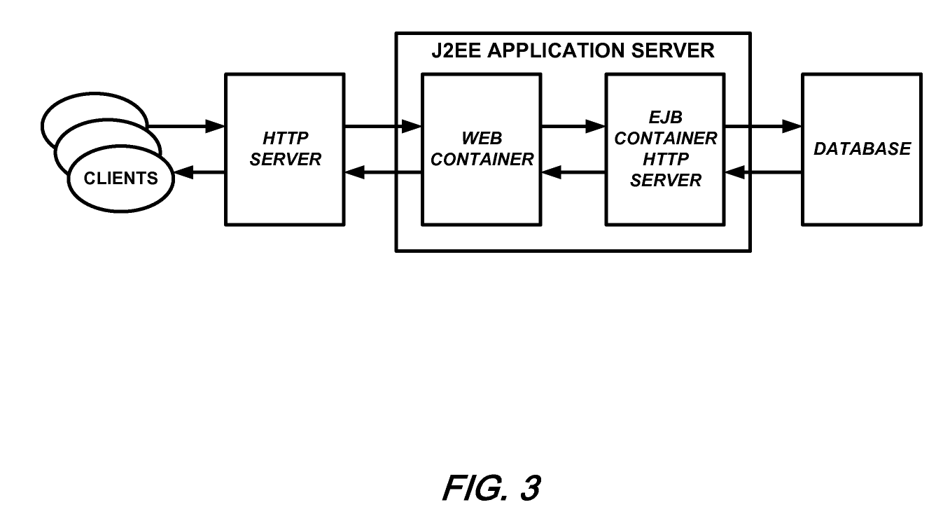

An exemplary implementation of the present invention has been tested on a real e-commerce application which is based on a J2EE multi-tiered architecture. J2EE is a widely adopt middleware standard for constructing enterprise applications from reusable Java modules, called Enterprise Java Beans (EJBs). The structure of an exemplary system under test is shown in FIG. 3.

One or more clients serve as our experimental load generator. In particular, the client(s) will generate HTTP requests of the HTTP server. For this test, we use Apache as the web server. The application middleware server includes a web container (Tomcat) and the EJB container (JBoss). The backend database is accessed via SQL and MySQL is running at the back end to provide persistent storage of data. PetStore 1.3.1 is deployed as our experimental test bed application. Its functionality comprises of a store front, shopping cart, purchase tracking among others—all of which should be familiar to those skilled in the art.

As experimentally implemented, there are 47 components in PetStore, including EJBs and Servlets. A client emulator is to generate a workload similar to that created by typical user behavior. The emulator produces a varying number of concurrent client connections with each client simulating a session, which consists of a series of requests such as creating new accounts, searching, browsing for item details, updating user profiles, placing order and checking out. Our experiments are conducted under these simulated workloads.

In the experiment we apply CCA and PCCA based methods respectively to model the contextual relationship between system load and database usage. The system load data are obtained from the Apache server log. We discover 12 different client HTTP request types issued in PetStore, including category.screen, product.screen, item.screen, cart.do, search.screen, createuser.do, createcustomer.do, j_signon_check, signon_welcome.screen, signoff_do, enter_order_information screen, and order_do.

Note the parameters in HTTP request, such as item_id and product_id, are not considered. As a result, the input vector ûₜ is defined as consisting of 12 variables. Each variable in ûₜ represents the number of specific type of client request issued within certain time interval Δt, observed at time t. Here we choose Δt=10 s. Similarly we find out 6 independent database tables from MySQL database log including category, product, UserEJB, AccountEJB, AddressEJB, and CounterEJB. The vector \hat{x}ₜ is defined to represent the number of different database tables accessed within Δt. Considering the time delays for transmitting client requests, we define u=[ûₜ \hat{x}_{t-Δt} û_{t-Δt}], x=\hat{x}ₜ to account for the effect caused by time delay.

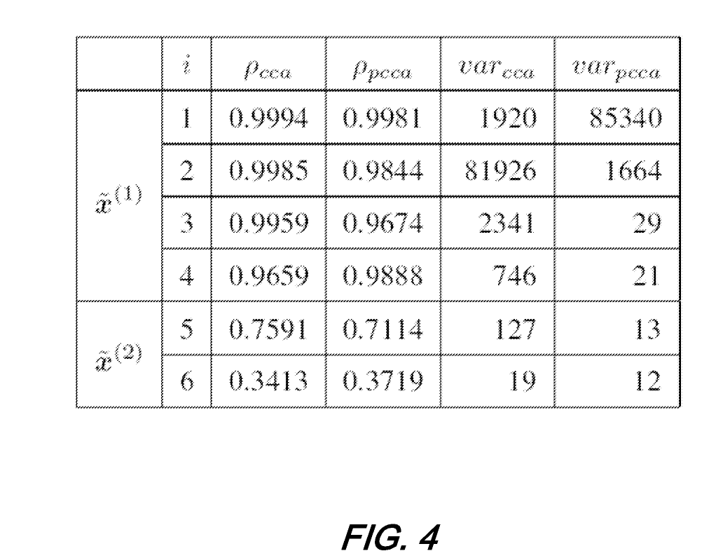

The training data are collected under the system's normal operation and divided into two parts. The first part of observations are used to calculate the correlation parameters, such as vectors wu(i), wx(i), and _i, i=1; 2; . . . ; m, m=6, for CCA and PCCA respectively. FIG. 4 is a table showing the values of ρ₁s and the variances extracted by each component \tilde{x}ᵢ as calculated from (15). Note the total variances of x are the same in both CCA and PCCA cases, which is the summation of all values in var column. Based on the magnitude of ρᵢ the original space x is divided into two subspaces, \tilde{x}⁽¹⁾ and \tilde{x}⁽²⁾, with dimension 4 and 2 respectively in both the CCA and PCCA cases. It can be seen from the table of FIG. 4 that the variances extracted by \tilde{x}⁽¹⁾ are higher in the PCCA case than those extracted by CCA method.

The remaining training data are used to sequentially update the ρᵢs and s score, and then determine their thresholds for anomaly. We sequentially calculate the covariances (11) and update each correlation ρᵢ according to equation (1). The threshold for each ρᵢ is determined as max(mᵢ−3σᵢ,0.01), where mᵢ is the mean observation of ρᵢ obtained from the training set, and σᵢ is its standard deviation. The function max(:; :) is used to reduce the false positives caused by some training data with extremely small or zero variances. Similarly the score s in (12) is also sequentially updated and its threshold is determined based on the confidence level ρ=0.999 for χ₂ distribution with two degree of freedom, according to the discussion presented earlier.

Several test datasets are generated under system normal states or situations where different faults have been injected. We modify the codes in some EJB components to simulate a variety of real system faults and compare the performances of CCA and PCCA based detectors. The experimental results for each test case are presented in the following sections. In each case, the curves of ρᵢ and s together with their thresholds are plotted, in which the first 300 samples are related to the training data set, and the remaining parts are values calculated from test observations.

Normal Data

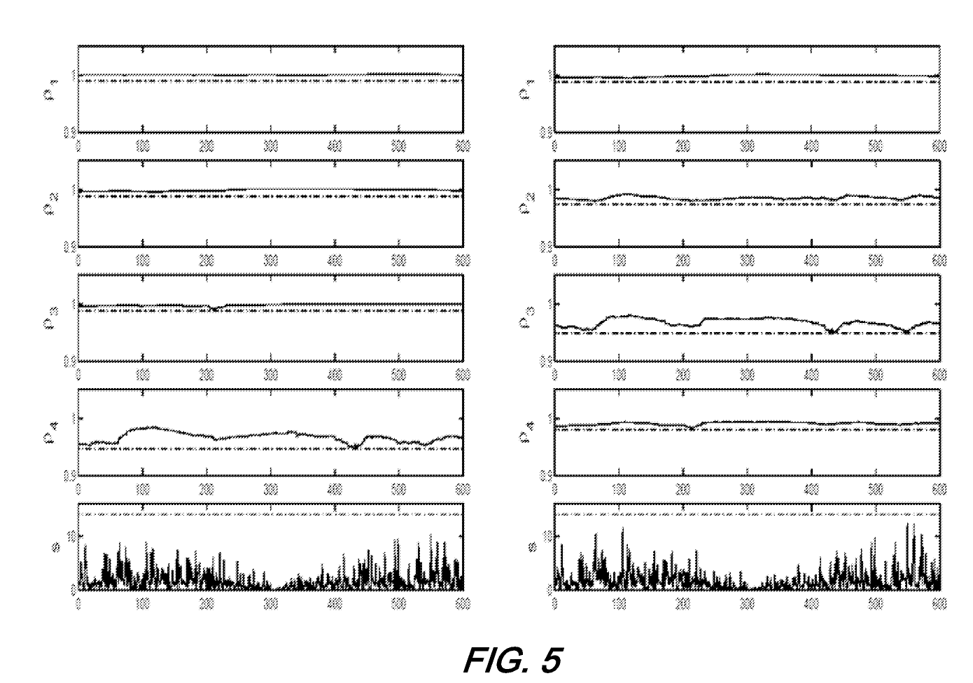

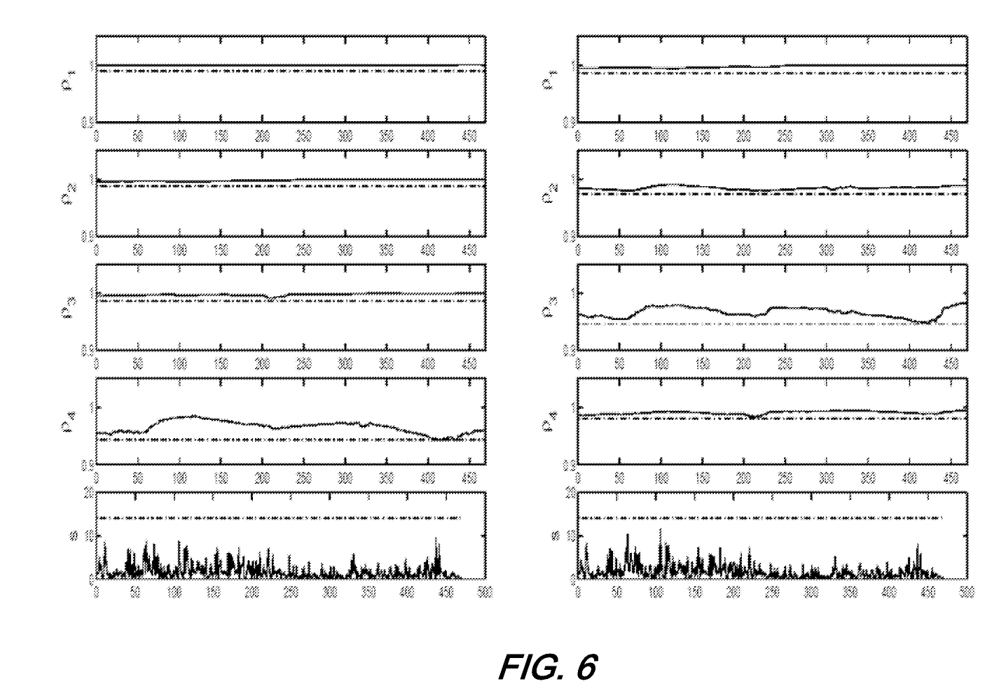

Two component test data sets are generated under system normal operations with different workload. The experimental results for these two data sets are shown in FIG. 5 and FIG. 6 respectively. In each of the two figures, the left column presents correlation and s score curves calculated by CCA method, and the right column curves are obtained by PCCA. The threshold for each measure is plotted as a dashed line in figures. It is shown that both CCA and PCCA based approaches work well for these two data sets. Advantageously, there are no false positives reported.

Memory Leaking

Memory leaking refers to a software bug where an application program repeatedly allocates virtual memory, but never deletes it. It is one of the major software bugs that severely threaten system availability and security. As can be readily appreciated by those skilled in the art, a program having a memory leak may exhaust system resources and eventually leading to program crashes.

The detection of this problem is not easy because a program with a memory leak is not obviously incorrect, and may even produce the correct output or calculate the proper results. Memory leaks are often not evident until a program has been executing successfully for hours, days, or weeks. Compounding the detection problem is the observation that it is also not always obvious which program is causing the memory leak.

One commonly adopted approach to avoid memory leaking is to use the type-safe language such as Java. Through a mechanism known as garbage collection, Java takes care of allocating and freeing memory automatically. However, the job of the garbage collector does not guarantee that memory leaking problem will disappear in Java programs because it only discards those objects that are no longer referenced. For the case when an object is always referred but its internal contents are no longer needed, the garbage collector can not detect it.

Based on this idea, we modify the code of a persistent EJB object, ShoppingCartLocalEJB, in PetStore to simulate the memory leaking problem. We create a collection class object, and add an additional procedure that always allocates new objects in the collection without any intention of releasing its usages. Since the reference of collection object is always pointed from other objects, the garbage collector does not know whether the inside of the collection is useful any more or not. Hence the PetStore application will gradually exhaust the supply of virtual memory pages, which leads to severe performance issue and make the accomplishment of client requests much slower. As a result, contextual correlation model learned during system normal status does not hold anymore when the system is slow down.

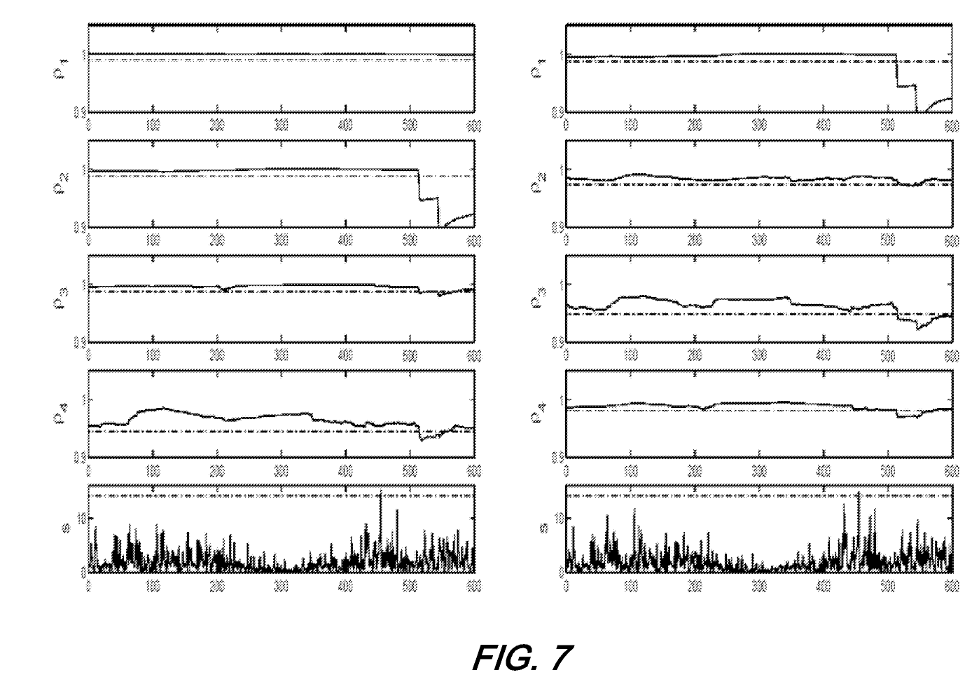

The experimental results shown in FIG. 7 verified our conclusion. As shown in FIG. 7, both CCA and PCCA can detect this fault. In the CCA method, the canonical correlation ρ₂ drops significantly below the threshold, which is the same as what ρ₁ does in PCCA method. In addition, other correlation scores, such as ρ₃ and ρ₄, and the s score all illustrate deviated behaviors from the thresholds.

File Missing

As can be readily appreciated, a File Missing type of fault is one of the common operational mistakes detected by a human. Before we deploy a Java Web application, it is always required to make a package of the application that follows a specific manner of file compositions. In the process of packaging, whether performed manually or automatically, it might happen that a file is improperly dropped from the required composition. In addition, some files might be deleted by some careless human operations when people try to manipulate a configuration after system release.

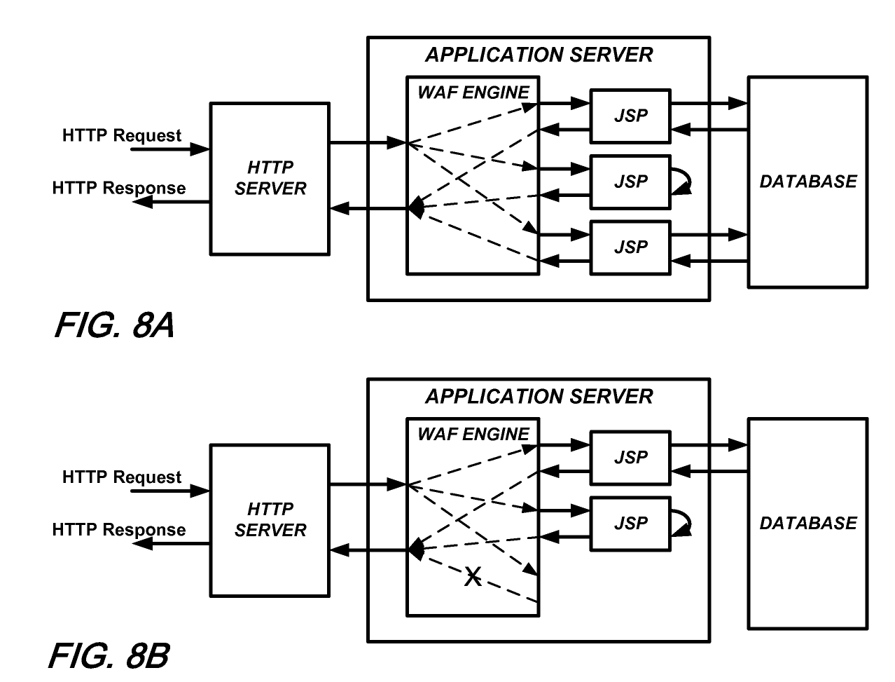

As mentioned before, to accomplish a specific HTTP request, a series of system resources such as Servlet, JSP and EJB components will be invoked. The correctness of the HTTP response depends on the correct services provided by those components. Even a slight service malfunction will make the user come across some strange web pages. For example, if a file describing JSP is dropped, the client will encounter some wrong information, such as the date, in the returned web page. Such failure does not cause any error messages in web server since it is masked in the application sever level, as shown in FIG. 8(b).

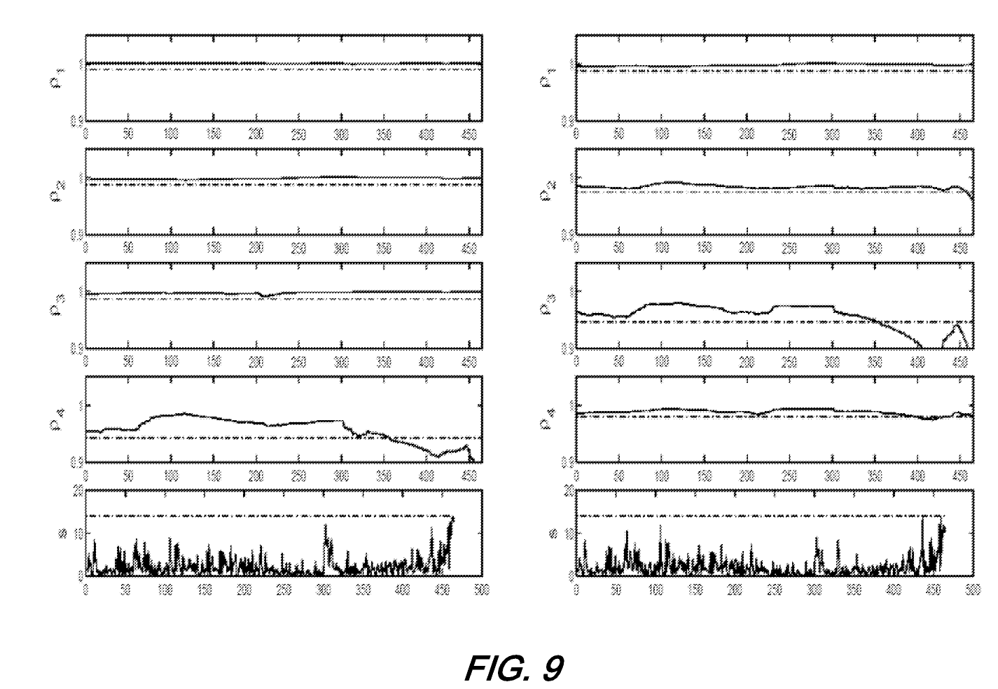

Advantageously, the present invention is applicable to this kind of failure since the database usage information is utilized. The file missing will significantly affect the usage pattern of database. From the results shown in FIG. 9: Results of File Missing. (a) canonical correlation and s score curves obtained from CCA; (b) canonical correlation and s score curves obtained from PCCA. The dashed lines are the thresholds. From these figures, we see that the evidences for the failure are strong enough to be detected by both CCA and PCCA based methods.

Component Faults

The causes of system failures are too diverse to be completely covered in our test bed. Therefore, instead of simulating individual faults that lead to actual failures, in the following parts we focus on reproducing the impacts of system failures. These impacts can be resulted from different causes, but are commonly encountered in real failure cases.

The failure impacts are represented as two factors namely, significance and phenomenon. The significance denotes the amount of client requests get affected by simulation. In the following cases, we will simulate both weak failures that only affect a very small number of user requests, and failures that affect frequent user requests. The phenomenon of failures can be quite a few. We present four types of commonly encountered phenomenon in the following sections: (1) deadlock; (2) busy loop; (3) expected exception; (4) null call.

Deadlock

To evaluate deadlock failures, we modify the function updateItemQuantity( ) in ShoppingCartLocalEJB, in which a variable is introduced to intermittently trigger the thread to sleep for a while and then recover. The purpose of this modification is to simulate the impact of deadlock software failure.

Consider the case when the ShoppingCartLocalEJB component becomes deadlocked with other threads due to competing for the same database resources, all the functionalities of ShoppingCartLocalEJB will become silent just like the thread is in the sleep mode. However, after a while when the database deadlock management tools will detect this deadlock and release it, the component ShoppingCartLocalEJB becomes alive again.

The significance of this injection is only for those requests that will pass through the component Shopping-CartLocalEJB. By tuning the frequency of the trigger, we simulate that around 5 percent of requests passing the ShoppingCartLocalEJB component will get locked for a time period between 2 and 4 seconds. As a result, only a very small percentage of user requests will get delayed for a very short period of time. This impact is weak and hard to be detected by traditional tools since the application is still working correctly and the clients still get the correct pages.

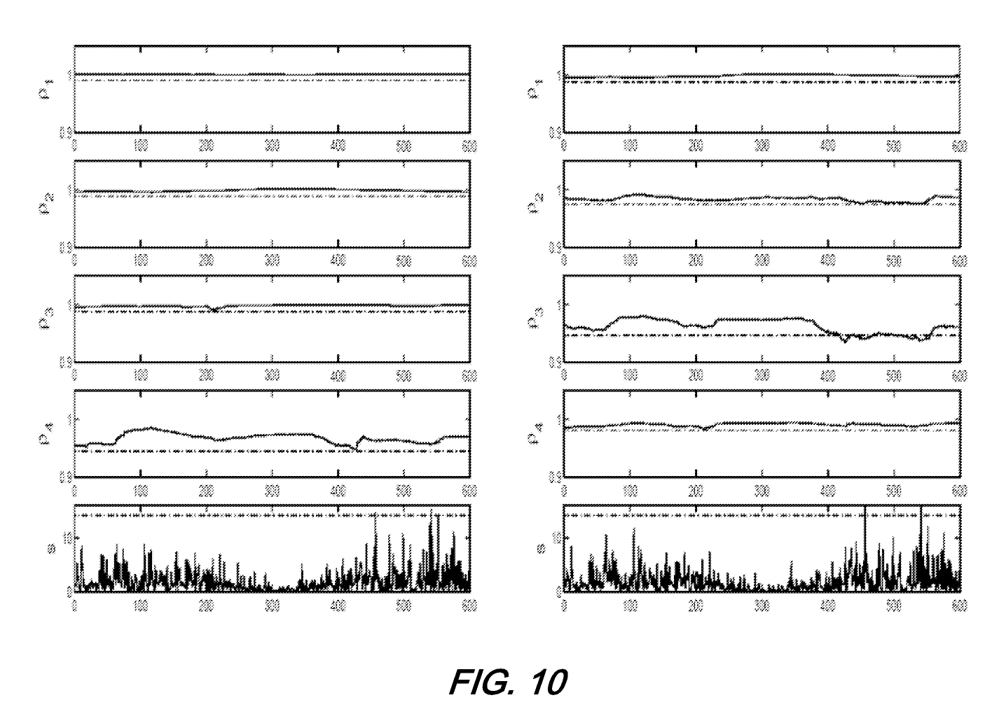

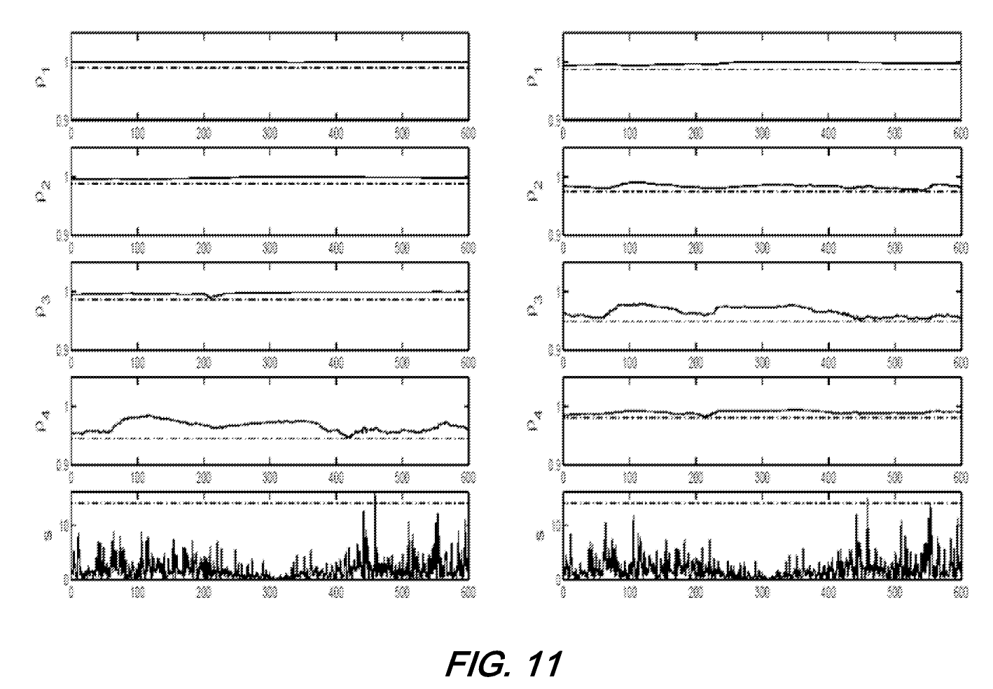

The detection results by our approaches are shown in FIG. 10. FIG. 19(a) illustrates that only s score is slightly affected by that software bug in CCA based detection. Such evidence is so flimsy that it might be some false positives. On the other hand, PCCA based detection demonstrated more reliable detection results. As shown in FIG. 10(b), both the correlation ρ₃ and the s score are affected in PCCA based method. The drop of ρ₃ curve is very clear and provides more confidence for detection.

As can be readily appreciated by those skilled in the art, this failure case exhibits the advantages of PCCA over CCA in failure detection tasks. Since PCCA takes into account the variances in the process of subspace estimation, it can more easily detect the changes in distribution of x.

Busy Loop on Rare Requests

We simulate the request slowdown by adding a busy loop procedure in the code. The actual causes of slowdown can be quite a few, such as the spin lock fault among synchronized threads. Depending on the position of instrumentation, the significance of the simulation is different. In this section we simulate such failure with very weak impact. After instrumentation, only one every a thousand user requests gets affected. Accordingly very weak evidences are found in both the CCA and PCCA based approaches. As shown in FIG. 11, only s score is trivially affected.

Busy Loop on Frequent Requests

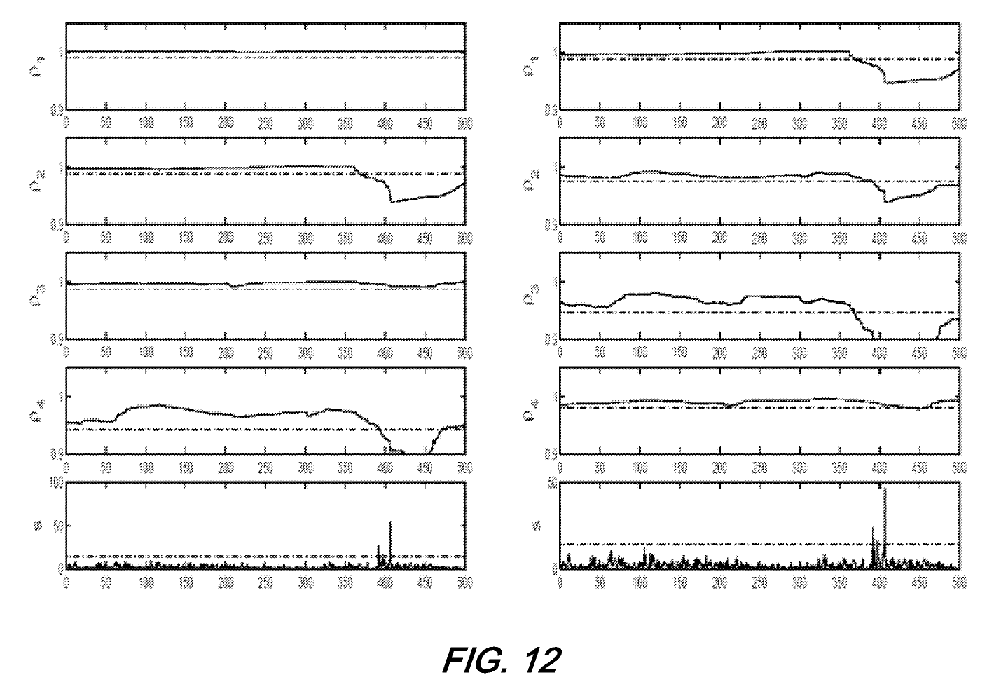

This failure is the same as the one described previously pertaining to Busy Loop on Rare Requests. However, the significance of simulation is substantially increased by changing the instrumentation position in source code. After instrumentation, all the client requests that go through the ShoppingCartLocalEJB component get affected. The experimental results shown in FIG. 12 demonstrate good performances in dealing with this failure case. The correlation and s curves show significant changes in both CCA and PCCA based methods.

Expected Exception

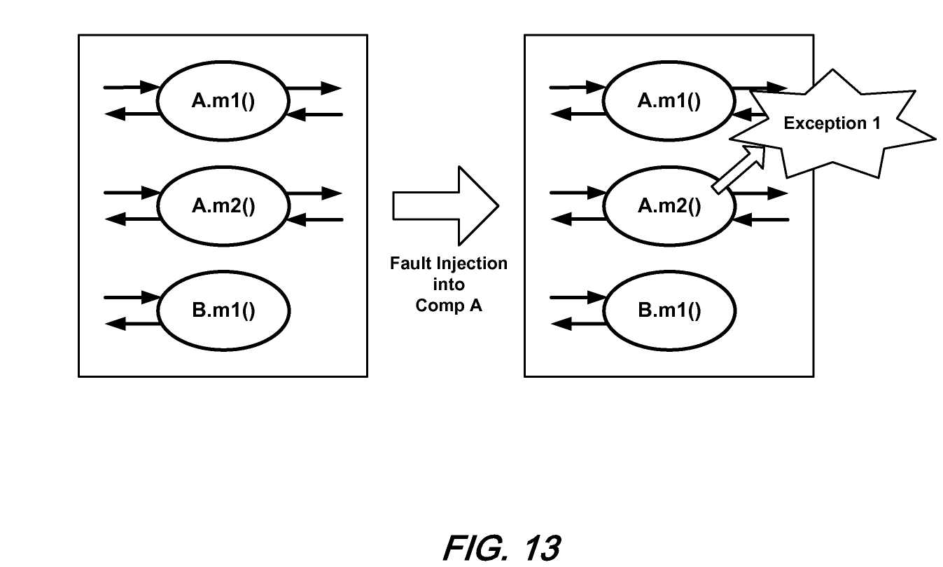

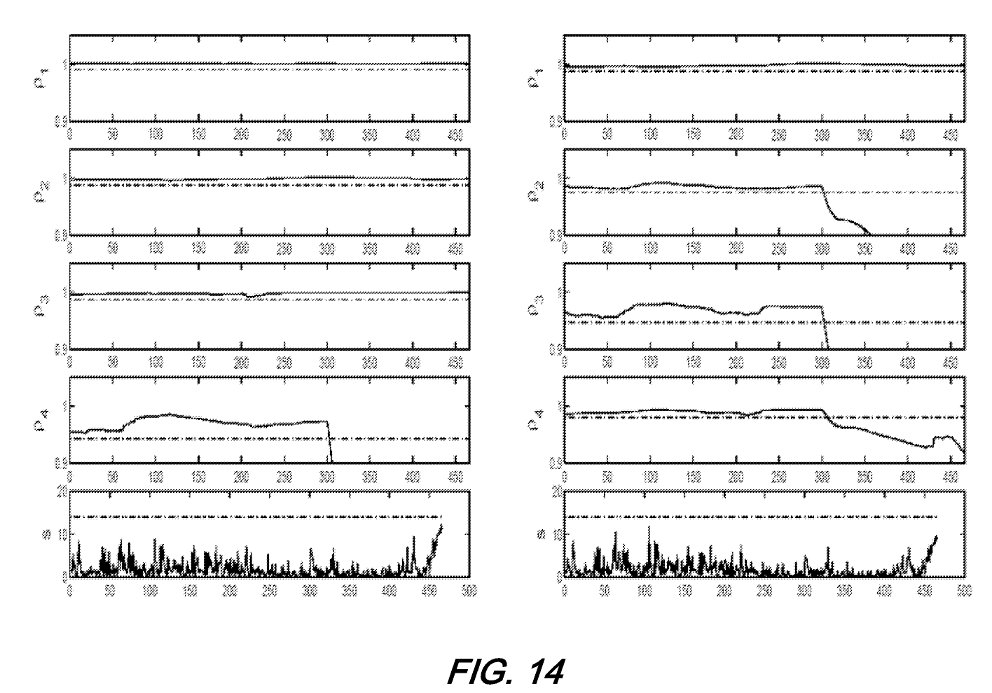

An expected exception fault happens when a method declaring exceptions (which appear in the method's signature) is invoked. In this situation an exception is thrown without the method code being executed. Applications are expected to handle gracefully and/or mask from end user such exceptions. FIG. 13 shows the behavior of component A before and after expected exception fault is injected. As shown in FIG. 13, only method A.m2( ) is declared with a throwable exception. No faults in other methods, such as A.m1( ), are triggered. Even though the expected exceptions can often be masked directly by the application code, it is still possible in real situations that they are not handled well and then turn into run time failures.

Turning now to FIG. 14, we see that the expected exception fault only influences the canonical correlation curves and has no effect on the s score. As can be seen from that FIG. 14, both CCA and PCCA methods can detect this fault. However, PCCA shows stronger indication since three correlation curves, ρ₂, ρ₃ and ρ₄, are significantly affected by the expected exception fault, while only one correlation ρ₄ is affected in CCA method. Note the traditional detection tools, which are based on the operational statistics such as response time, are not able to detect such fault because the expected exception does not crash the application software and the response time for delivering the client requests are still within normal thresholds.

Null Call

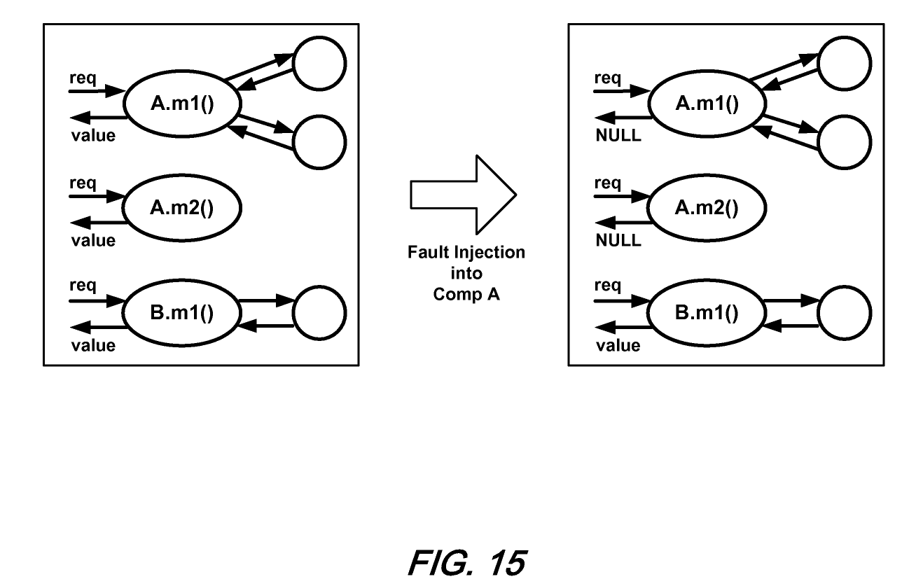

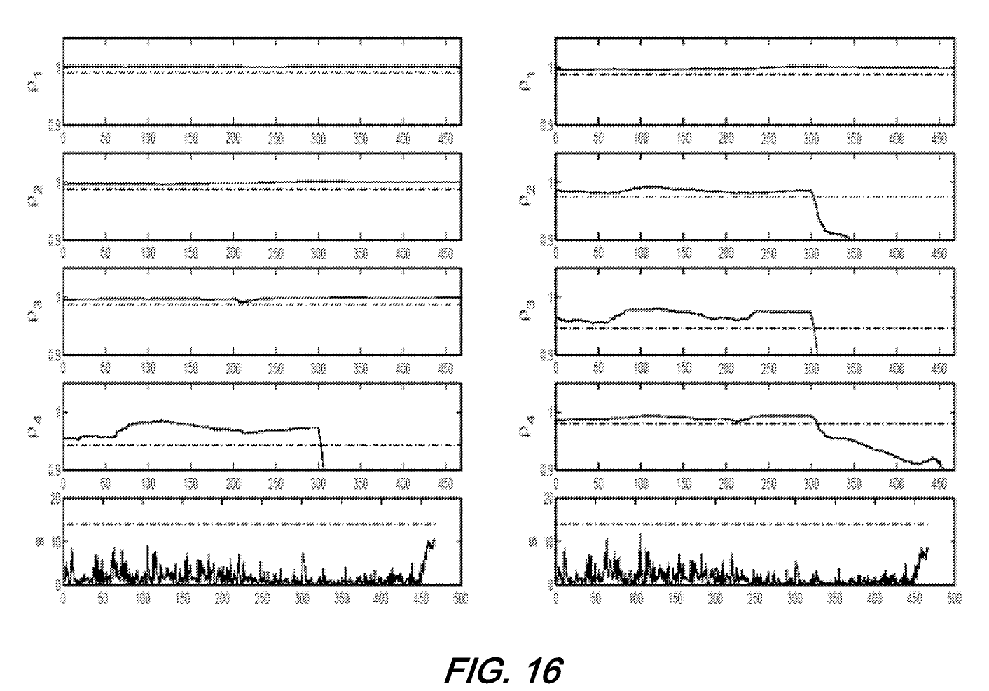

A null call fault causes all methods in the affected component to return a null value without executing the methods' code. When this fault is injected into component A, as shown in FIG. 15, all the methods in A return immediately a null value, without calling further components. Null call like situations can arise at runtime from failure to allocate certain resources, failed lookups, etc.

Similar to the expected exception, the null call fault results in subtle outcomes, and does not cause exceptions to be printed on an operator's console, and does not crash the application software. On the other hand, these bugs can easily happen in practice due to incomplete, or incorrect, handling of rare conditions. The detection results of null call fault, as shown in FIG. 16, are very similar to those in the expected exception case.

At this point those skilled in the art will readily appreciate that we have presented two new approaches for failure detection in distributed systems. We utilized the information about system input and proposed the concepts of supervised and unsupervised monitoring. The database usages have been monitored to reflect the system status. By using statistical learning, the variables about the database usage are divided into two subsets. One is highly correlated with the input, and each variable in that subset is monitored with the aid of a teacher. The other variable subset accounts for the variables that are less correlated or uncorrelated with the input, which is monitored in an unsupervised way. Two statistical approaches have been proposed to decompose the variable space: CCA and PCCA. Their differences exist in the fact that PCCA techniques considers the coverage of variances as well as the correlation in the process of subset extraction. Because of this property, PCCA usually gets more accurate results in failures with weak impacts. The experiment results on in a real e-commerce application show that both CCA and PCCA works well for most simulated failure cases. In addition, PCCA showed more confident evidences in case of the failures that have weak impact.

Finally, it is understood that the above-described embodiments are illustrative of only a few of the possible specific embodiments which can represent applications of the invention. Numerous and varied other arrangements can be made by those skilled in the art without departing from the spirit and scope of the invention.

What is claimed is:

1. A system failure detection method comprising the steps of:
monitoring the system to determine the occurrence of a failure;
the method characterized by the steps of:
modeling a normal behavior of the system;
detecting anomalies using the learned model(s); and
locating faulty components by correlating the anomalies.

2. The method of claim 1 further characterized by the step of:
updating the model(s) during system operation.

3. The method of claim 2 further characterized by the steps of:
collecting training data during normal system operation;
splitting those data into two datasets; and
extracting CCA parameters using the first one of the two extracted datasets.

4. The method of claim 3 further characterized by the site of:
determining a threshold for correlation(s) between particular members of the first dataset.

5. The method of claim 4 wherein said CCA parameters comprise canonical covariate pairs (ũᵢ,\tilde{x}ᵢ) and their correlation ρᵢ where i=1, 2, . . . , m, with decreasing correlations ρ₁≧ρ₂≧ρₘ.

6. The method of claim 5 wherein said threshold determining step is further characterized by the steps of:
updating covariance matrices Cₓₓ Cᵤᵤ Cₓᵤ
updating canonical correlations ρᵢ; and
determining a statistical threshold for values of ρᵢ.

7. The method of claim 6 wherein said threshold is determined to be a predetermined standard deviation below a mean value.

8. The method of claim 7 wherein said predetermined standard deviation is 3× below a mean value.

9. The method of claim 8 wherein said covariance matrices Cₓₓ Cᵤᵤ Cₓᵤ are updated according to the relationship: Cₓᵤ^{k+1}=γCₓᵤ^{k}+(1−γ)x^{k}(u^{k})^{⊥}.
